(19) United States
(12) Patent Application Publication
(10) Pub. No.: US 2005/0129259 A1
(43) Pub. Date: Jun. 16, 2005

(54) Telephone headset with in-use indicator

(76) Inventor: Clint D. Garner, Omaha, NE (US)

Correspondence Address: HARSHAW RESEARCH INCORPORATED, P O BOX 418, OTTAWA, KS, 66067, US

(21) Appl. No.: 10/735,389

(22) Filed: Dec. 12, 2003

(51) Int. Cl. H04R 9/08; H04R 11/04; H04R 17/02

(52) U.S. Cl. 381/172; 381/362; 381/361

(57) ABSTRACT

A telephone headset includes a support structure for supporting the headset hands-free on a user's head, an earpiece for transmitting sounds to a user's ear, and a boom having a first end connected to the support structure and a second end containing a microphone that can be positioned near a user's mouth. The boom has a side facing away from the user's head with a groove formed therein extending along a length of the boom. A plurality of LEDs are positioned in the groove and are spaced apart along the length of the boom. The LEDs are arranged in the groove so as to be completely shielded from the user's eyes when the headset is supported on the user's head. A control circuit with a flasher is provided for flashing the LEDs when the telephone is in-use. Variations of the light source, the control circuit, and the headset structure are disclosed.

### BACKGROUND OF THE INVENTION

1. Field of the Invention

The present invention relates generally to telephone headsets that attach hands-free onto the head of a user. In particular, the present invention relates to telephone headsets having an in-use indicator thereon for indicating that the person wearing the headset is on the telephone.

2. Description of the Related Art

A large portion of the workforce today is involved in the service industry. More than ever before, this means spending large amounts of time on the telephone. Although telephone headsets have made this level of phone time tolerable, our “phone etiquette” has yet to account for the use of headsets—particularly in an office environment. When using headsets, it is not obvious at a glance whether or not an officemate is engaged in a telephone conversation or available to speak with. The visual clues that warn us that a colleague is speaking on the telephone (e.g., a handheld receiver cradled against the user's face) are typically not available with headsets. Thus, a telephone call may be interrupted inadvertently by direct verbal communication with the colleague. The colleague must then either interrupt the person attempting to communicate directly, or interrupt the telephone conversation. Also, if the colleague is wearing a headset, others may forgo direct communication thinking that the colleague is in the middle of a telephone conversation, even when he or she is not.

Commercial headsets include an ear-clip design that attaches directly to a user's ear, and an over-the-head design that uses a headband over the top of the user's head. Both types of headsets typically include a boom extending from a support near the earpiece for mounting a microphone near the user's mouth. An example of the ear-clip design is the Plantronics Model T50 headset, and an example of the over-the-head design is the Plantronics Model T10 headset. The ear-clip designs are typically smaller, more lightweight, and sleeker in design and appearance as compared to the over-the-head designs. The over-the-head designs typically look bulkier, but are more stable and typically provide slightly better sound quality. Both of these headset designs can be used with the Applicant's invention, as described below.

A number of telephone headsets having in-use indicators exist in the prior art. For example, U.S. Pat. No. 5,210,791 to Krasik discloses a telephone headset on-line indicator that determines the “on-line” or “off-hook” condition by monitoring the voltage potential across the two transmitting lines between the headset and the telephone base unit. A light emitting diode at the end of the microphone boom, or mechanisms for lighting up the entire boom are provided. When the phone is “off-hook” or other in-use condition is determined, the circuitry lights up the diode or the microphone boom to indicate that the user is “on-line” and should not be disturbed.

U.S. Pat. No. 5,359,647 to Regen et al. discloses a headset in-use indicator that utilizes a transformer and amplifier circuit to amplify the audio signals across the transmission lines to determine if the telephone headset is in use or off-hook. A signal activates an LED at the end of the microphone boom. A flasher circuit is provided for flashing the LED during an in-use condition of the telephone.

U.S. Pat. No. 5,608,794 to Larson discloses a telephone headset in-use indicator having an indicator lamp attached directly onto the boom next to the mouthpiece. Larson also discloses a variation in which the in-use indicator comprises a lamp located through the entire boom. These in-use indicators each include a control circuit that automatically turns the indicator lamp on when an “off-hook” telephone connection is detected.

U.S. Patent Publication No. 2002/0064276 A1 to Winegar discloses a telephone headset having an in-use indicator light positioned at the end of an elongated extension member above the user's head.

These prior art designs have certain shortcomings and disadvantages that appear to have limited their success and widespread adoption in the marketplace. For example, the in-use indicators disclosed by Krasik, Larson and Regen et al. use a single LED positioned at the end of the boom near the user's mouth. The use of a single LED prevents the indicator from being readily visible from the side or the back, making it ineffective for persons who are not located directly in front of the person wearing the headset.

The variations disclosed by Krasik and Larson in which the entire boom is illuminated during an in-use condition would obviously improve the ability of the in-use indicator to draw attention to itself. However, the headset user is then exposed to the indicator light, which creates other adverse effects, particularly if a flasher circuit is employed. The adverse effects if the headset user is exposed to a flashing in-use indicator light could range from annoyance to nausea.

The in-use indicator of Winegar protrudes above the headset making it more bulky and more likely to be bumped and otherwise interfere with the user's comfort while wearing the headset. Also, having the in-use indicator positioned at the end of an extension member away from the headset is less intuitive making it less effective for those not familiar with its function.

Thus, there is a need in the industry for an improved in-use indicator for telephone headsets.

### SUMMARY OF THE INVENTION

An object of the present invention is to provide a telephone headset having an in-use indicator that solves the problems in the existing devices described above.

More specifically, it is an object of the present invention to provide a telephone headset having an in-use indicator that uses strategically placed lighting to indicate that the headset is in use without adversely affecting the headset user.

It is a further object of the present invention to provide an in-use indicator for telephone headsets that is highly visible from multiple angles, that does not require large amounts of power or add significantly to a headset's weight, that uses a flashing light to increase visibility, and that allows the headset to be cost competitive with other sets on the market.

It is a further object of the present invention to provide a telephone headset having an in-use indicator that is simpler, more compact, and more intuitive than a separate unit.

It is a further object of the present invention to provide an in-use indicator for a telephone headset that provides an interesting visual effect by altering the flashing light dependent on the volume of incoming or outgoing sound.

In order to accomplish these and other objects of the invention, a telephone headset having an in-use indicator is provided that illuminates a strategically placed light emitting device to advise others when the headset is in use. The telephone headset includes a support structure for supporting the headset hands-free on a user's head, an earpiece for transmitting sounds to a user's ear, and a boom having a first end connected to the support structure and a second end containing a microphone that can be positioned near a user's mouth. The boom has a side facing away from the user's head with a groove formed therein extending along a length of the boom. In the preferred embodiment, a plurality of LEDs are positioned in the groove and are spaced apart along the length of the boom. The LEDs are arranged in the groove so as to be completely shielded from the user's eyes when the headset is supported on the user's head. A control circuit with a flasher is provided for flashing the LEDs when the telephone is in-use. A modulating circuit can be used to activate different LEDs based on the detected volume of incoming and outgoing sound.

According to a broad aspect of the present invention, a headset is provided for receiving and sending voice communications. The headset includes a support structure for supporting the headset hands-free on a user's head, and a boom connected to the support structure for positioning a microphone adjacent to a user's mouth. The boom has a first side facing the user's head and a second side facing away from the user's head, and a groove is formed in the second side of the boom. A plurality of spaced-apart lights are positioned in the groove on the second side of the boom, and are operable to provide an in-use indicator for the headset.

According to another broad aspect of the present invention, a telephone headset is provided, comprising: a support structure for supporting the headset hands-free on a user's head; and a boom connected to the support structure for positioning a microphone near a user's mouth. The boom has a side facing away from the user's head and a groove formed in said side. At least one light source is positioned in the groove on the boom and arranged such that the light source is completely shielded from the user's eyes to provide an in-use indicator for the headset that does not bother the user.

According to yet another broad aspect of the present invention, a telephone headset is provided, comprising: a support structure for supporting the headset hands-free on a user's head, the support structure including an earpiece for transmitting sounds to a user's ear; a boom having a first end connected to the support structure and a second end containing a microphone for receiving sounds from a user's mouth. The boom has a side facing away from the user's head, and a groove formed therein that extends along substantially an entire length of the boom from the first end to the second end. A plurality of LEDs are positioned in the groove and spaced apart along the length of the boom. The LEDs are arranged so as to be completely shielded from the user's eyes when the headset is supported on the user's head. A control circuit with a flasher is provided for flashing the LEDs when the telephone headset is in-use.

Numerous other objects of the present invention will be apparent to those skilled in this art from the following description wherein there is shown and described a preferred embodiment of the present invention, simply by way of illustration of some of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the invention is made with reference to the accompanying drawings. In the drawings:

FIG. 1 is a perspective view of a person using the telephone headset according a first embodiment of the present invention;

FIG. 2 is an enlarged perspective view of the telephone headset having a lighted in-use indicator according to the first embodiment of the present invention;

FIG. 3 is a block diagram showing the logic of the in-use indicator including timer-based flashing and volume-based modulation;

FIG. 4a is a right-side view of a person using a telephone headset according to a second embodiment of the present invention;

FIG. 4b is a left-side view of the person using the telephone headset according to the second embodiment of the present invention;

FIG. 5a is a side view of the person using the telephone headset as shown in FIG. 4a, illustrating a first set of energized lights corresponding to a low volume conversation;

FIG. 5b is a side view of the person using the telephone headset as shown in FIG. 4a, illustrating a second set of energized lights corresponding to a high volume conversation;

FIG. 6 is a perspective view of a telephone headset having a lighted in-use indicator according to a third embodiment of the present invention.

### DETAILED DESCRIPTION OF THE INVENTION

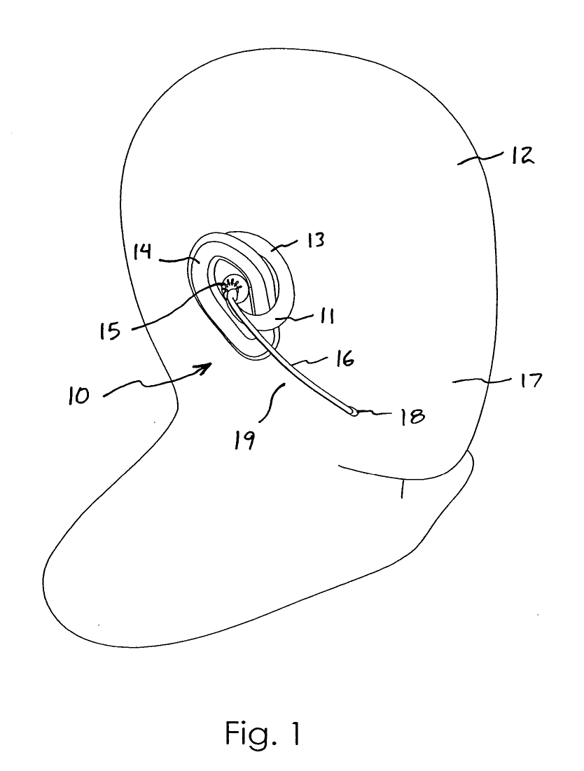

A telephone headset having a lighted in-use indicator according to preferred embodiments of the present invention will now be described in detail with reference to FIGS. 1 to 6 of the drawings.

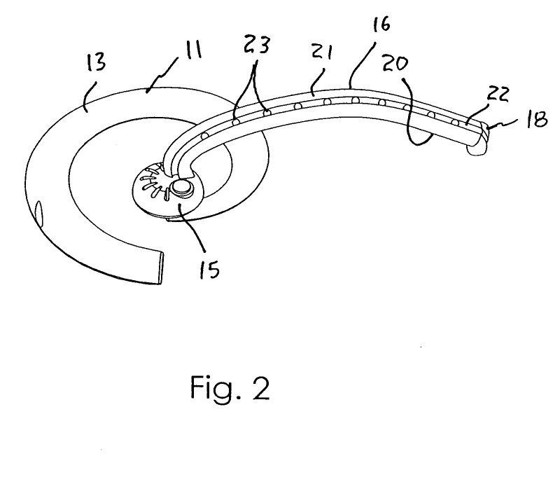

A first embodiment of the telephone headset 10 is shown in FIGS. 1 and 2. The headset 10 according to the first embodiment has a support structure 11 in the form of an ear-clip configuration for supporting the headset 10 hands-free on a user's head 12. The ear-clip configuration includes a curved member 13 that fits over and rests on the top of the user's ear 14.

An earpiece 15 is connected at one end of the curved member 13 for positioning a small speaker near the user's ear 14 for transmitting incoming sounds to the user's ear 14. The earpiece 15 can be formed integral with the curved member 13 or as a separate component. The term “support structure” is broadly used herein to refer to both the earpiece 15 and the structure 11 for supporting the headset 10 on the user's head 12, whether these components are formed integral or as separate components.

A boom 16 is connected to the support structure 11 and extends forwardly from the earpiece 15 to a point near the user's mouth 17. The primary function of the boom 16 is to position a microphone 18 adjacent to the user's mouth 17 and to house the wires that connect the microphone 18 to the earpiece 15 and to the rest of the telephone system. The boom 16 typically has a gentle curve shape that conforms to the side 19 of the user's head 12 to provide a sleeker and more attractive appearance.

The boom 16 has a first side 20 facing the user's head 12, and a second side 21 facing away from the user's head 12. The second side 21 of the boom 16 has a groove 22 formed therein that extends along a length of the boom 16 from the earpiece 15 to the microphone 18. A plurality of spaced-apart lights 23 are positioned in the groove 22 along the length of the boom 16. The lights 23 are preferably LEDs, although other light sources could also be used. The lights 23 are operable to provide an in-use indicator for the headset 10.

Having the lights 23 positioned on the boom 16 in close proximity to the user's face offers substantial advantages over conventional in-use indicators placed at the telephone base or on a separate unit. The placement of in-use indicator lights 23 on the boom 16 is more intuitive than other locations for the in-use indicator because the human eye tends to search out faces instinctively. Thus, while a detached light may be overlooked, a light in close proximity to a face is likely to be noticed. Care can then be taken by others to avoid speaking to a person engaged in a phone conversation on the telephone headset 10. The placement of lights 23 on the boom 16 also provides a simpler and more compact design having fewer wires to drag or tangle.

Many in-use indicator lights placed on telephone headsets use incandescent bulbs to provide high visibility. However, because incandescent bulbs have large power requirements and generate high amounts of heat, wearable headsets using incandescent bulbs are difficult to design. To overcome this problem, the present invention uses flashing lights, preferably LEDs, as the indicator lights 23 to achieve high visibility without high luminous intensities. A flashing light is much more visible than a steady light at any particular intensity. In practice, this means that dimmer, less energy intensive lights 23 can be used to achieve the same level of visibility. This is true for any observer whose line of sight is within 180 degrees of the illumination source, which is an advantage for any headset indicator attempting to draw attention to itself.

Unfortunately, one of the observers capable of seeing the flashing light of a headset would be the headset's user. Especially if the flashing is continuous, the constant exposure can have adverse effects ranging from annoyance to nausea. The higher visibility and lower power usage inherent in an intermittently lit headset are great advantages if this obstacle can be overcome.

Accordingly, an important part of the present invention is the groove 22 formed in the boom 16. The groove 22 functions to shield the flashing lights 23 from the eyes of the headset user, while allowing the lights 23 to be highly visible to others. The groove 22 is positioned on the second side 21 of the boom 16 facing away from the user's head 12 and is arranged to point away from the user's eyes at all points along the second side 21 of the boom 16. Thus, the lights 23 positioned in the groove 22 are placed entirely behind the headset boom relative to the user's head 12, as directly opposed to the user's eyes as possible. The dimensions of the groove 22 should be such that the user's eyes are completely shielded from light rays emitted from the indicator lights 23 placed within the groove 22.

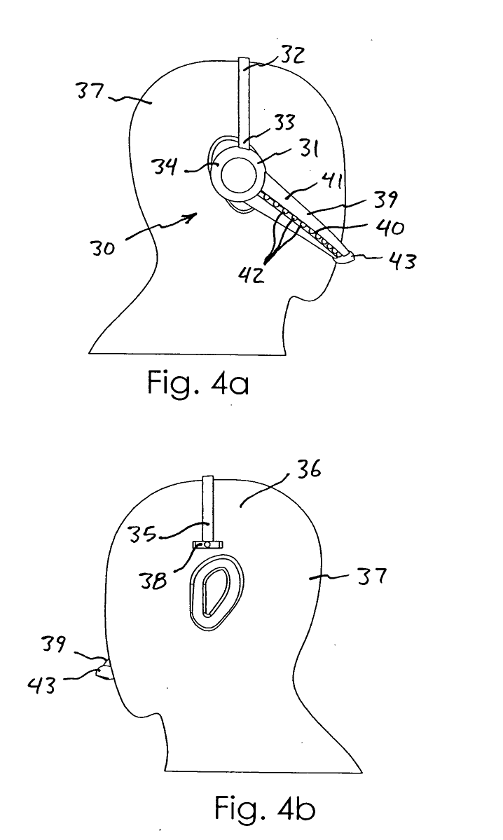

FIGS. 4a and 4b illustrate right and left views of a person wearing a telephone headset 30 according to a second embodiment of the present invention. The support structure 31 on the telephone headset 30 according to this second embodiment includes a headband 32 having a first end 33 attached to a body 34 of the headset 30, and a second free end 35 adapted to engage an opposite side 36 of a user's head 37. An additional light 38 is positioned at the free end 35 of the headband 32 on a side facing away from the user's head 37 to provide an additional in-use indicator for the headset 30. The boom 39 of the headset 30 according to this second embodiment is substantially the same as the boom 39 of the headset 30 shown in FIG. 2, as described above. Specifically, the boom 39 includes a shallow groove 40 formed in a side 41 thereof facing away from the user's head 37, and a plurality of indicator lights 42 spaced along the boom 39 and positioned within the groove 40.

A control circuit is used to activate the indicator lights 23, 42 during an in-use condition of the telephone headset 10, 30 for both the first and second embodiments described above. The basic configuration of the control circuit can be, for example, any of the conventional circuits disclosed in U.S. Pat. No. 5,210,791 to Krasik, which circuits and their accompanying descriptions are incorporated herein by reference. The control circuit determines when the telephone headset 10, 30 is in-use and then causes the indicator lights 23, 42 to flash at a selected frequency during such in-use condition.

To achieve the flashing action of the lights, several conventional circuit configurations are possible. In general, a device that functions as a timer will periodically interrupt the flow of power to the indicator lights 23, 42. The most common timer circuit in use commercially is the so-called 555 chip. The 555 chip is a simple and robust integrated circuit that costs less than fifty cents. The frequency of flashing provided by the 555 chip can be adjusted easily by connecting the chip to a variable resistor and/or an adjustable capacitor that can be adjusted by turning a knob or the like. By placing the adjustment knob on the headset 10, 30, the user can easily adjust the blinking frequency to suit his or her specific needs or preferences.

The control circuit of the present invention can also include a modulating means for altering the flashing lights dependent on the volume of incoming and/or outgoing sound signals. For example, the indicator lights 23, 42 spaced along the length of the boom 16, 39 in either of the first and second emdodiments can be made to operate similar to a stereo system's equalizer bars, which depict the volume of the music. The modulation can be accomplished with the control circuit by comparing the sound signal to a selected standard, and activating a certain light or group of lights when the signal exceeds this level. Each indicator light 23, 42 can have its standard set at a slightly higher level than the neighboring light on the right or left. National Semiconductor's LM3916 dot/bar display driver is a commercially available circuit suitable for this application.

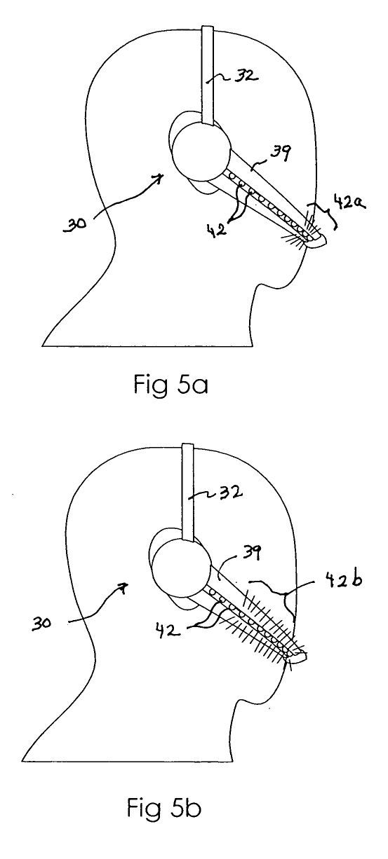

FIGS. 5a and 5b depict the volume-dependent operation of the indicator lights 42 on the headset 30. FIG. 5a shows a first group of the indicator lights 42a closest to the microphone 43 being activated, indicating a low volume level transmission. FIG. 5b shows an additional group of indicator lights 42b being activated, indicating a higher volume level transmission. These figures illustrate the appearance of the headset 30 as the volume level gets progressively louder. The modulation of the lights 23, 42 based on the volume level can be used in addition to the timer-based flashing, thus ensuring the added visibility afforded by the flashing action even when the volume remains relatively constant.

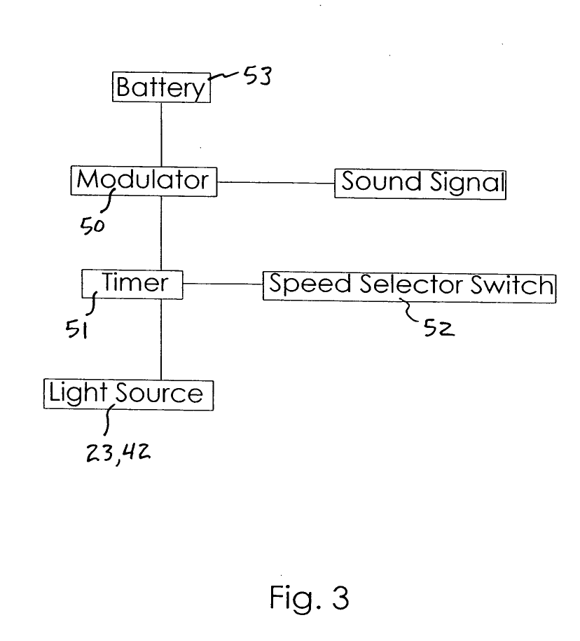

FIG. 3 is a block diagram showing the logic of the control circuit of the in-use indicator including both timer-based flashing and volume-based modulation. As shown in this diagram, the control circuit of the headset includes a volume modulator chip 50 and a timer chip 51, both of which are explained above. The modulator chip 50 receives the incoming and/or outgoing sound signals as inputs and determines which indicator lights 23, 42 on the boom 16, 39 should be activated. The timer chip 51 receives inputs from a speed selector switch 52 on the headset 10, 30 to determine the frequency and/or duration of the flashing of the indicator lights 23, 42. A battery 53 or other conventional power source provides the power supply for the control circuit.

In operation, the control circuit first determines when the headset 10, 30 is in-use, which can be accomplished using any of a variety of conventional methods and circuitry. The control circuit uses the modulator chip 50 to determine which of the indicator lights 23, 42 to activate based on the volume level of the incoming and/or outgoing sound signals. The control circuit uses the timer chip 51 to cause the selected indicator lights 23, 42 to flash during the in-use condition. For example, during a telephone conversation when neither party is speaking, only the first few indicator lights 23a, 42a on the boom 16, 39 are activated and caused to flash, as shown in FIG. 5a, to indicate to others that the telephone headset 10, 30 is in use. When incoming sounds are detected or when the volume of such sounds increases, the modulator chip 50 causes additional indicator lights 23b, 42b on the boom 16, 39 to be activated, as shown in FIG. 5b. These additional indicator lights 23b, 42b are also caused to flash by the timer chip 51, making the in-use indicator very visible and intuitive to those around the headset user.

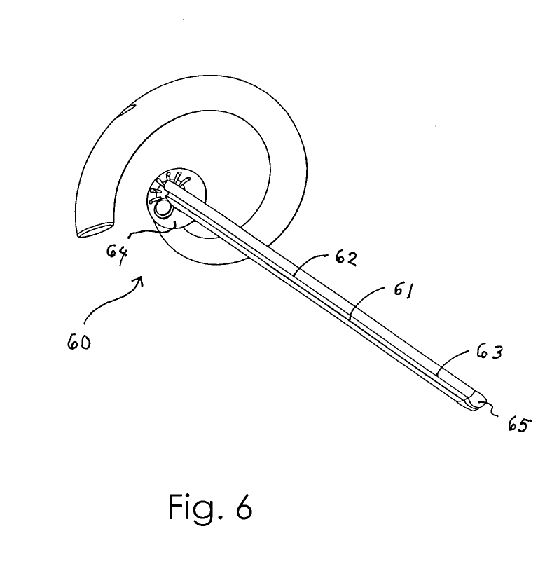

FIG. 6 illustrates a telephone headset 60 according to another embodiment of the present invention. This telephone headset 60 is similar to the headset 10 shown in FIG. 2, except that a monolithic light device 61 is used instead of a plurality of indicator lights. The boom 62 has a shallow groove 63 extending along its length from the earpiece 64 to the mouthpiece 65. The monolithic light device 61 is positioned within the groove 63 and thereby shielded from the user's eyes to avoid any adverse effects caused by the in-use indicator being visible to the headset user. The monolithic light device 61 can be operated in a manner similar to the indicator lights 23 used in the FIG. 2 embodiment, with appropriate changes being made to the control circuit to accommodate the different light source. The monolithic light device 61 can be modulated to provide volume-dependent operation, and also can be flashed using a timer chip, similar to the operation of the indicator lights 23 in the FIG. 2 embodiment described above. However, instead of determining which of a plurality of lights 23 to activate, the length of illumination of the monolithic light device 61 can be controlled simply by changing the voltage level used to activate the light device 61.

While the invention has been specifically described in connection with specific embodiments thereof, it is to be understood that this is by way of illustration and not of limitation, and the scope of the appended claims should be construed as broadly as the prior art will permit.

1. A headset for receiving and sending voice communications, comprising:
a support structure for supporting the headset hands-free on a user's head;
a boom connected to the support structure for positioning a microphone adjacent to a user's mouth, said boom having a first side facing the user's head and a second side facing away from the user's head, and said second side of the boom having a groove formed therein; and
a plurality of spaced-apart lights positioned in the groove on the second side of the boom, said lights being operable to provide an in-use indicator for the headset.

2. The headset according to claim 1, wherein said support structure comprises an ear-clip configuration that attaches to a user's ear.

3. The headset according to claim 1, wherein said support structure comprises a headband having a first end attached to a body of the headset and a free end adapted to engage an opposite side of a user's head.

4. The headset according to claim 3, further comprising at least one additional light positioned at the free end of the headband, said additional light being operable to provide an additional in-use indicator for the headset.

5. The headset according to claim 1, wherein said groove formed in the second side of the boom is arranged to point away from the user's eyes at all points along the second side of the boom and thereby shield the user's eyes from light emitted from the spaced-apart lights during an in-use condition of the headset.

6. The headset according to claim 1, further comprising a control circuit for activating said spaced-apart lights, said control circuit comprising a modulating means for determining which of the spaced-apart lights to activate based on a detected volume of incoming or outgoing sound.

7. The headset according to claim 6, wherein said modulating means is arranged to activate more of the spaced-apart lights as the detected volume gets louder.

8. The headset according to claim 6, wherein said control circuit further comprises a means for flashing at least some of the spaced-apart lights during an in-use condition of the headset.

9. The headset according to claim 1, further comprising a control circuit for activating said spaced-apart lights, said control circuit comprising a means for flashing the spaced-apart lights to indicate an in-use condition of the headset.

10. The headset according to claim 1, wherein said control circuit further comprises a means for adjusting a frequency of flashing provided by said flashing means.

11. The headset according to claim 1, wherein said lights are LEDs.

12. The headset according to claim 1, wherein said boom has a first end adjacent to the support structure and a second end adjacent to the microphone, and said groove extends along substantially an entire length of the boom between the first and second ends.

13. A telephone headset, comprising:
a support structure for supporting the headset hands-free on a user's head;
a boom connected to the support structure for positioning a microphone near a user's mouth, said boom having a side facing away from the user's head and a groove formed in said side; and
at least one light source positioned in the groove on the boom and arranged such that the light source is completely shielded from the user's eyes to provide an in-use indicator for the headset that does not bother the user.

14. The telephone headset according to claim 13, wherein said at least one light source is a plurality of LEDs positioned in the groove and spaced along a length of the boom.

15. The telephone headset according to claim 13, wherein said at least one light source is a monolithic strip placed within the groove and extending along a length of the boom.

16. The telephone headset according to claim 13, further comprising a control circuit for determining an in-use condition of the headset and activating the light source during said in-use condition.

17. The telephone headset according to claim 16, wherein said control circuit includes a flasher means for causing the light source to flash during said in-use condition.

18. The telephone headset according to claim 16, wherein said at least one light source is a plurality of LEDs positioned in the groove and spaced along a length of the boom, and wherein said control circuit includes a modulator means for modulating which LEDs are activated during said in-use condition based on a detected volume of incoming or outgoing sound.

19. A telephone headset, comprising:
a support structure for supporting the headset hands-free on a user's head, said support structure including an earpiece for transmitting sounds to a user's ear;
a boom having a first end connected to the support structure and a second end containing a microphone for receiving sounds from a user's mouth, said boom having a side facing away from the user's head and a groove formed in said side, said groove extending along substantially an entire length of said boom from said first end to said second end;
a plurality of LEDs positioned in the groove on the boom and spaced apart along the length of the boom, said LEDs being arranged so as to be completely shielded from the user's eyes when the headset is supported on the user's head; and
a control circuit with a flasher for flashing the LEDs when the telephone is in-use.

20. The telephone headset according to claim 19, wherein said control circuit includes a modulator means for modulating which LEDs are activated when the telephone is in-use based on a detected volume of incoming or outgoing sound.
